(19) United States
(12) Patent Application Publication
(10) Pub. No.: US 2026/0042227 A1
(43) Pub. Date: Feb. 12, 2026

(54) TORQUE SENSING BIONIC CLAMPING JAW

(71) Applicant: XI’AN JIAOTONG UNIVERSITY, Xi'an (CN)

(72) Inventors: Yu SUN, Xi'an (CN); Ling WANG, Xi'an (CN); Laihao YANG, Xi'an (CN); Yuxuan SUN, Xi'an (CN); Xuefeng CHEN, Xi'an (CN)

(21) Appl. No.: 18/953,773

(22) Filed: Nov. 20, 2024

(30) Foreign Application Priority Data
Aug. 8, 2024 (CN) 2024110845559

(51) Int. Cl. B25J 13/08; B25J 15/02

(52) U.S. Cl. CPC B25J 13/082; B25J 15/026

(57) ABSTRACT

Disclosed is a torque sensing bionic clamping jaw. In the torque sensing bionic clamping jaw, a left clamping jaw skeleton is movably connected to a substrate, the left clamping jaw skeleton includes a first left groove and a second left groove which are in a side facing a right jaw, a left sensor quick-release connecting piece is detachably connected to the first left groove, a left torque measuring sensor is mounted on the left sensor quick-release connecting piece, a left flexible gasket quick-release connecting piece is detachably connected to the second left groove, and a left flexible gasket is mounted on the left flexible gasket quick-release connecting piece; a right torque measuring sensor is mounted on a right sensor quick-release connecting piece and opposite to the left torque measuring sensor, and a right flexible gasket is mounted on a right flexible gasket quick-release connecting piece.

### CROSS-REFERENCE TO RELATED APPLICATION

This application claims priority from the Chinese patent application 2024110845559 filed Aug. 8, 2024, the content of which is incorporated herein in the entirety by reference.

### TECHNICAL FIELD

The present disclosure relates to the technical field of manipulator jaws, in particular to a torque sensing bionic clamping jaw.

### BACKGROUND

In today's society, food processing has become an indispensable part of people's daily life. In the process of food processing, vegetable cutting is an essential link. However, a traditional vegetable-cutting manner generally requires precise control of hands of people. It is difficult for an existing mechanical clamping jaw to clamp a cutter and sense the clamped cutter, resulting in that a technology of cutting vegetables cannot be really learnt. Besides, the mechanical clamping jaw lacks a torque sensing function, such that the mechanical clamping jaw cannot judge a state of a cut object when using the cutter, and cannot achieve intelligent vegetable cutting, and a bionic clamping jaw with the torque sensing function, capable of clamping the cutter, and providing enough clamping force and torsional resistance is expected to bring convenience and comfort for people's life, improving the food processing efficiency and safety.

Information disclosed in the background art is only used to enhance understanding of the background of the present disclosure, and may therefore contain information that does not constitute the prior art publicly known by those ordinarily skilled in the art.

### SUMMARY

As for deficiency or defects existing in the prior art, a torque sensing bionic clamping jaw is provided, parallel to a motor in a clamping jaw substrate to drive a clamping jaw skeleton to horizontally move, achieving grabbing a tool. The introduction of a torque sensor enables a mechanical clamping jaw to have a torque sensing function and a clamping pressure sensing function. The introduction of flexible gaskets increases torque that the tool can bear.

Objectives of the present disclosure are implemented through the following technical solutions.

A torque sensing bionic clamping jaw includes:
a substrate,
a left jaw, movably connected to the substrate, wherein the left jaw includes:
a left clamping jaw skeleton, movably connected to the substrate, wherein the left clamping jaw skeleton includes a first left groove and a second left groove which are in a side facing a right jaw,
a left sensor quick-release connecting piece, detachably connected to the first left groove,
a left torque measuring sensor, mounted on the left sensor quick-release connecting piece,
a left flexible gasket quick-release connecting piece, detachably connected to the second left groove, and
a left flexible gasket, mounted on the left flexible gasket quick-release connecting piece; and
a right jaw, movably connected to the substrate and spaced parallelly relative to the left jaw, wherein the right jaw includes:
a right clamping jaw skeleton, movably connected to the substrate, wherein the right clamping jaw skeleton includes a first right groove and a second right groove which are in a side facing the left jaw,
a right sensor quick-release connecting piece, detachably connected to the first right groove,
a right torque measuring sensor, mounted on the right sensor quick-release connecting piece and opposite to the left torque measuring sensor,
a right flexible gasket quick-release connecting piece, detachably connected to the second right groove, and
a right flexible gasket, mounted on the right flexible gasket quick-release connecting piece and opposite to the left flexible gasket;
wherein after the left jaw and the right jaw clamp an object, the left torque measuring sensor and the right torque measuring sensor detect torsion data of the object, and the left flexible gasket and the right flexible gasket form a lever with the left torque measuring sensor and the right torque measuring sensor.

In the torque sensing bionic clamping jaw, the second left groove and the second right groove are both provided with notches.

In the torque sensing bionic clamping jaw, the first left groove and the first right groove are both provided with clamping protrusions.

In the torque sensing bionic clamping jaw, the left sensor quick-release connecting piece is provided with a left positioning groove for positioning the left torque measuring sensor, and the right sensor quick-release connecting piece is provided with a right positioning groove for positioning the right torque measuring sensor.

In the torque sensing bionic clamping jaw, a depth of the second left groove is half of a thickness of the left flexible gasket, and a depth of the second right groove is half of a thickness of the right flexible gasket.

In the torque sensing bionic clamping jaw, the left clamping jaw skeleton and the right clamping jaw skeleton are both of an L-shaped structure.

In the torque sensing bionic clamping jaw, the L-shaped structures are provided with reinforcing ribs.

In the torque sensing bionic clamping jaw, the reinforcing ribs are triangular ribs.

In the torque sensing bionic clamping jaw, the left clamping jaw skeleton and the right clamping jaw skeleton are slidably connected to the substrate through a screw rod.

In the torque sensing bionic clamping jaw, the torque sensing bionic clamping jaw is of a symmetrical structure.

Compared with the prior art, the present disclosure has the beneficial effects:
the present disclosure may adapt to multi-dimensional cutters or other objects, the usage range is wide, and the cost is low. Based on the detection capacity for torsion of a cutter in a plane, a mechanical clamping jaw can well complete various tasks in the field of home life. A manner of combining an electric screw rod with a torque sensor enables the mechanical clamping jaw to keep stable and controllable in the process of cutting vegetables.

The description is only an instruction of the technical solutions of the present disclosure, in order to make technical means of the present disclosure more clear and explicit, and achieve the degree of implementing by those skilled in the art according to contents of the specification, and in order to make the description of the present disclosure, other objectives, features and advantages be more apparent and easy to understand, specific implementations of the present disclosure are illustrated below.

### BRIEF DESCRIPTION OF DRAWINGS

By reading detailed descriptions in the preferable specific implementations below, other various advantages and benefits of the present disclosure will become clear and explicit for those ordinarily skilled in the art. Accompanying drawings of the specification are only used to show objectives of preferable implementations, and are not considered as limitations to the present disclosure. Apparently, the accompanying drawings described below are only some embodiments of the present disclosure, and those ordinarily skilled in the art may further obtain other accompanying drawings according to these accompanying drawings without creative labor. In addition, in the entire accompanying drawings, the same accompanying drawing labels represent the same component.

In the accompanying drawings:

FIG. 1 is a structural explosion schematic diagram of a torque sensing bionic clamping jaw of the present disclosure.

FIG. 2 is a schematic front view diagram of a torque sensing bionic clamping jaw of the present disclosure.

FIG. 3 is a schematic right view diagram of a torque sensing bionic clamping jaw of the present disclosure.

FIG. 4 is a schematic top view diagram of a torque sensing bionic clamping jaw of the present disclosure.

FIG. 5 is a schematic inclined view diagram of a torque sensing bionic clamping jaw of the present disclosure.

The present disclosure is further explained below in conjunction with the accompanying drawings and embodiments.

### DETAILED DESCRIPTION OF THE DISCLOSURE

Specific embodiments of the present disclosure will be described in detail referring to accompanying drawings. Although the specific embodiments of the present disclosure are shown in the accompanying drawings, it should be understood that the present disclosure may be implemented by various forms rather than being limited by embodiments explained here. On the contrary, these embodiments are provided to understand the present disclosure more thoroughly, and the scope of the present disclosure may be completely communicated to those skilled in the art.

It needs to be noted that some words are used in the specification and claims to refer to specific components. Those skilled in the art may understand that technical personnel may use different nouns to call the same component. The specification and claims do not use the difference of the nouns as a manner distinguishing the components, and use the difference of the components in function as a criterion for distinguishing. “Contain” or “include” mentioned in the entire specification and claims are open words, and should be explained as “contain but is not limited to”. The specification is subsequently described as preferable implementations of the present disclosure, but the description takes general principles of the specification as an objective, and is not used to limit the scope of the present disclosure. The scope of protection of the present disclosure will take the attached claim definer as a standard.

For facilitating understanding of the embodiments of the present disclosure, a plurality of specific embodiments will be taken as an example in conjunction with the accompanying drawings for further explanation, and the accompanying drawings do not constitute limitation to the embodiments of the present disclosure.

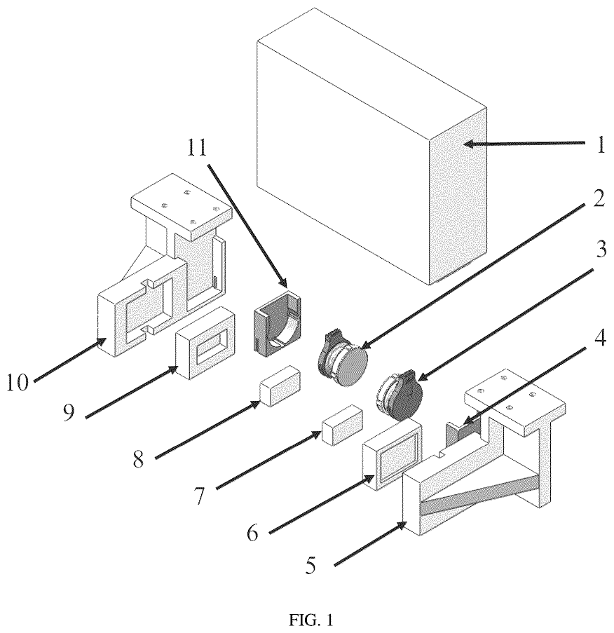

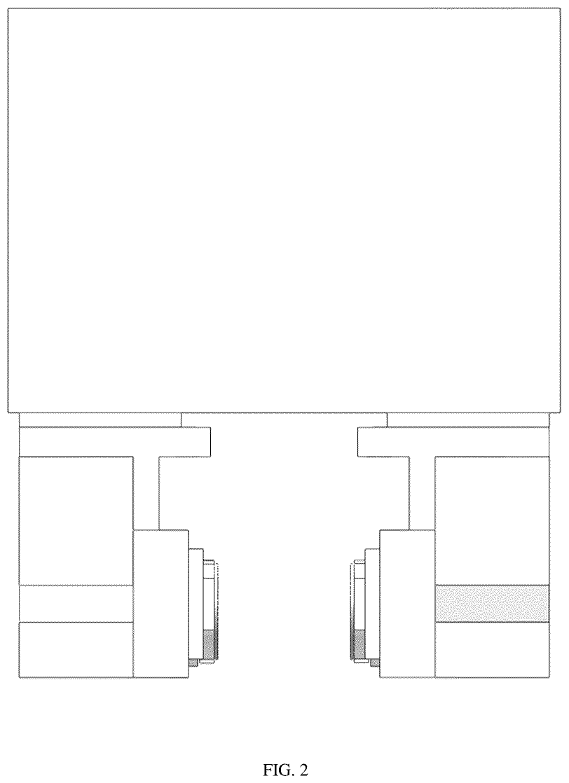

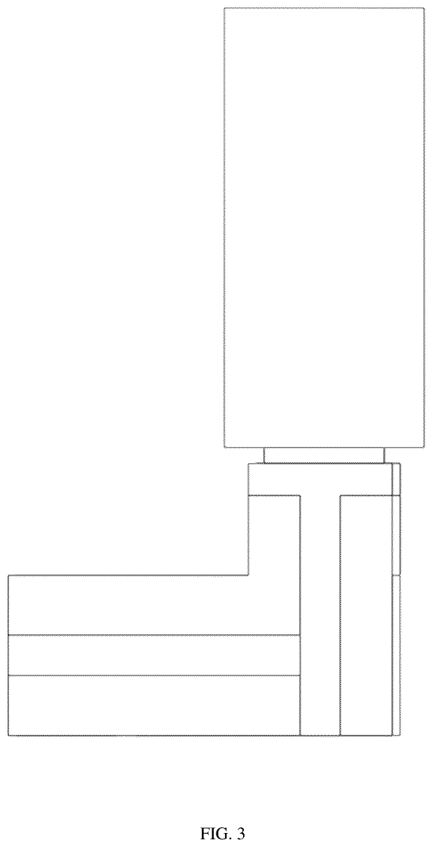

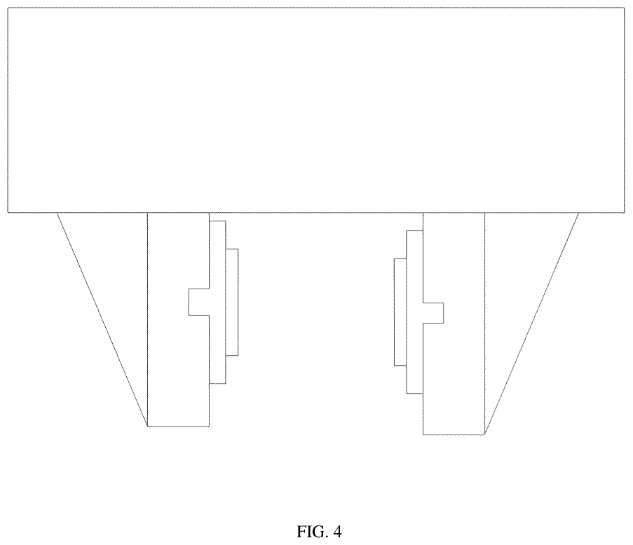

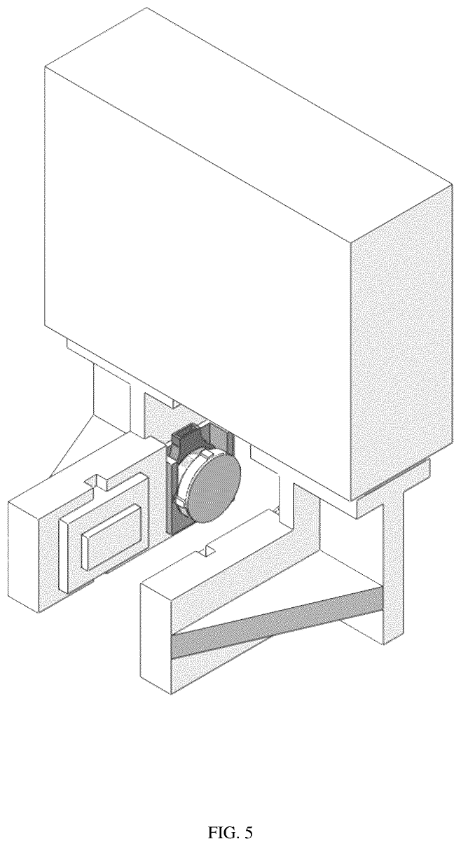

For better understanding, as shown in FIG. 1 to FIG. 5, a torque sensing bionic clamping jaw includes:
a substrate 1,
a left jaw, movably connected to the substrate 1, wherein the left jaw includes:
a left clamping jaw skeleton 5, movably connected to the substrate 1, wherein the left clamping jaw skeleton 5 includes a first left groove and a second left groove which are in a side facing a right jaw,
a left sensor quick-release connecting piece 4, detachably connected to the first left groove,
a left torque measuring sensor 3, mounted on the left sensor quick-release connecting piece 4,
a left flexible gasket quick-release connecting piece 6, detachably connected to the second left groove, and
a left flexible gasket 7, mounted on the left flexible gasket quick-release connecting piece 6; and
a right jaw, movably connected to the substrate 1 and spaced parallelly relative to the left jaw, wherein the right jaw includes:
a right clamping jaw skeleton 10, movably connected to the substrate 1, wherein the right clamping jaw skeleton 10 includes a first right groove and a second right groove which are in a side facing the left jaw,
a right sensor quick-release connecting piece 11, detachably connected to the first right groove,
a right torque measuring sensor 2, mounted on the right sensor quick-release connecting piece 11 and opposite to the left torque measuring sensor 3,
a right flexible gasket quick-release connecting piece 9, detachably connected to the second right groove, and
a right flexible gasket 8, mounted on the right flexible gasket quick-release connecting piece 9 and opposite to the left flexible gasket 7;
wherein after the left jaw and the right jaw clamp an object, the left torque measuring sensor 3 and the right torque measuring sensor 2 detect torsion data of the object and the left flexible gasket 7 and the right flexible gasket 8 with the left torque measuring sensor 3 and the right torque measuring sensor 2 form levers. When the clamping jaw clamps an object such as a cutter, a rear end of the cutter makes contact with the torque measuring sensors, and a middle of the cutter makes contact with the flexible gaskets. When a front end of the cutter is subjected to external force, the entire cutter will rotate taking the torque measuring sensors as supporting points. The torque measuring sensors and the flexible gaskets form lever action and simultaneously provide external force for resisting the cutter from rotating. The left flexible gasket and the left torque measuring sensor form a lever on one side, and the right flexible gasket and the right torque measuring sensor form a lever on the other side.

In the preferred embodiment of the torque sensing bionic clamping jaw, the second left groove and the second right groove are both provided with notches.

In the preferred embodiment of the torque sensing bionic clamping jaw, the first left groove and the first right groove are both provided with clamping protrusions.

In the preferred embodiment of the torque sensing bionic clamping jaw, the left sensor quick-release connecting piece 4 is provided with a left positioning groove for positioning the left torque measuring sensor 3, and the right sensor quick-release connecting piece 11 is provided with a right positioning groove for positioning the right torque measuring sensor 2.

In the preferred embodiment of the torque sensing bionic clamping jaw, a depth of the second left groove is half of a thickness of the left flexible gasket 7, and a depth of the second right groove is half of a thickness of the right flexible gasket 8.

In the preferred embodiment of the torque sensing bionic clamping jaw, the left clamping jaw skeleton 5 and the right clamping jaw skeleton 10 are both of an L-shaped structure.

In the preferred embodiment of the torque sensing bionic clamping jaw, the L-shaped structures are provided with reinforcing ribs.

In the preferred embodiment of the torque sensing bionic clamping jaw, the reinforcing ribs are triangular ribs.

In the preferred embodiment of the torque sensing bionic clamping jaw, the left clamping jaw skeleton 5 and the right clamping jaw skeleton 10 are slidably connected to the substrate 1 through a screw rod.

In the preferred embodiment of the torque sensing bionic clamping jaw, the torque sensing bionic clamping jaw is of a symmetrical structure.

In an embodiment, a range of the substrate 1 is 80 mm, the left clamping jaw skeleton and the right clamping jaw skeleton are arranged on the substrate in a mirroring mode, the left flexible gasket is mounted on one side of the left clamping jaw skeleton away from the substrate, the left torque sensor is mounted on one side of the left clamping jaw skeleton close to the substrate, the right torque sensor is mounted on one side of the right clamping jaw skeleton close to the substrate, and the right flexible gasket is mounted on one side of the right clamping jaw skeleton away from the substrate.

In an embodiment, a movable platform is arranged on the substrate, and the movable platform is provided with threaded holes. The clamping jaw skeletons are connected with the movable platform through bolts.

The sensor quick-release connecting pieces are anchored with the clamping jaw skeletons through buckle structures. The left flexible gasket quick-release connecting piece is connected with the left clamping jaw skeleton through an interference fit. The right flexible gasket quick-release connecting piece is connected with the right clamping jaw skeleton through an interference fit.

Preferably, the first left groove of the left clamping jaw skeleton and the protrusion of the left sensor quick-release connecting piece are mutually positioned and matched. The first right groove of the right clamping jaw skeleton and the protrusion of the right sensor quick-release connecting piece are mutually positioned and matched.

Preferably, grooves are formed in two sides of clamping jaw skeleton grooves matched with the flexible quick-release connecting pieces. Preferably, sensor base protrusions and sensor quick-release connecting piece grooves are mutually matched.

In an embodiment, as shown in FIG. 1, a torque sensing bionic clamping jaw includes a substrate 1, a right torque measuring sensor 2, a left torque measuring sensor 3, a left sensor quick-release connecting piece 4, a left clamping jaw skeleton 5, a left flexible gasket quick-release connecting piece 6, a left flexible gasket 7, a right flexible gasket 8, a right flexible gasket quick-release connecting piece 9, a right clamping jaw skeleton 10, and a right sensor quick-release connecting piece 11. The left clamping jaw skeleton 5 is provided with a first left groove for quickly positioning, allowing positioning and matching of the left sensor quick-release connecting piece 4 with it. The left clamping jaw skeleton 5 is provided with a second left groove for facilitating mounting of the left flexible gasket quick-release connecting piece 6, and notches are formed in two sides of the second left groove, facilitating replacement of the left flexible gasket quick-release connecting piece 6. The left sensor quick-release connecting piece 4 is provided with a left positioning groove, capable of positioning the left torque measuring sensor 3, and achieving matching of the two at the same time. The left flexible gasket quick-release connecting piece 6 is designed with a square groove, matched with the left flexible gasket 7, and a depth of the groove is equal to half of a thickness of the left flexible gasket 7. The left clamping jaw skeleton and the right clamping jaw skeleton are oppositely arranged on the substrate, and accessories on the two clamping jaws are the same. When the clamping jaws are used, a motor is started. The substrate pushes the clamping jaw skeletons to move oppositely, achieving clamping of a cutter or other objects. After an object is clamped, a sensor interface and the flexible gaskets may be all closely connected with the contact object. The torque measuring sensor can detect a torsion condition of the clamped object on a manipulator. The flexible gaskets and the torque measuring sensors form a lever, so that the integral torsion resistance degree of the manipulator is greatly increased, when a torsion angle of the cutter is too large or the cutter obviously slips, clamping force is adjusted again for an operation again, until when the manipulator operates the cutter, the cutter does not obviously slip or deflect with a large angle.

Basic principles of the present application are described above in conjunction with the specific embodiments, however, it needs to be noted that advantages, merits, effects and the like involved in the present application are only illustrative but not limitations, and it cannot be considered that these advantages, merits, effects and the like are necessary for the embodiments of the present application. In addition, specific details disclosed above are only for illustration and convenient understanding, and are not limitations, and the above details do not limit the present application to necessarily adopting the above specific details for implementation.

The above description has been given for illustrative and described objectives. In addition, the description is not intended to limit the embodiments of the present application to the form disclosed here. Although a plurality of example aspects and embodiments have been discussed above, those skilled in the art will know some deformations, modifications, changes, additions and sub-combinations thereof.

1. A torque sensing bionic clamping jaw, comprising:
a substrate,
a left jaw, movably connected to the substrate, comprising:
a left clamping jaw skeleton, movably connected to the substrate, comprising a first left groove and a second left groove which are in a side facing a right jaw,
a left sensor quick-release connecting piece, detachably connected to the first left groove,
a left torque measuring sensor, mounted on the left sensor quick-release connecting piece,
a left flexible gasket quick-release connecting piece, detachably connected to the second left groove, and
a left flexible gasket, mounted on the left flexible gasket quick-release connecting piece; and
a right jaw, movably connected to the substrate and spaced parallelly relative to the left jaw, comprising:
a right clamping jaw skeleton, movably connected to the substrate, comprising a first right groove and a second right groove which are in a side facing the left jaw,
a right sensor quick-release connecting piece, detachably connected to the first right groove,
a right torque measuring sensor, mounted on the right sensor quick-release connecting piece and opposite to the left torque measuring sensor,
a right flexible gasket quick-release connecting piece, detachably connected to the second right groove, and
a right flexible gasket, mounted on the right flexible gasket quick-release connecting piece and opposite to the left flexible gasket;
wherein after the left jaw and the right jaw clamp an object, the left torque measuring sensor and the right torque measuring sensor detect torsion data of the object, and the left flexible gasket and the right flexible gasket form a lever with the left torque measuring sensor and the right torque measuring sensor.

2. The torque sensing bionic clamping jaw according to claim 1, wherein preferably, the second left groove and the second right groove are both provided with notches.

3. The torque sensing bionic clamping jaw according to claim 2, wherein the first left groove and the first right groove are both provided with clamping protrusions.

4. The torque sensing bionic clamping jaw according to claim 1, wherein the left sensor quick-release connecting piece is provided with a left positioning groove for positioning the left torque measuring sensor, and the right sensor quick-release connecting piece is provided with a right positioning groove for positioning the right torque measuring sensor.

5. The torque sensing bionic clamping jaw according to claim 1, wherein a depth of the second left groove is half of a thickness of the left flexible gasket, and a depth of the second right groove is half of a thickness of the right flexible gasket.

6. The torque sensing bionic clamping jaw according to claim 1, wherein the left clamping jaw skeleton and the right clamping jaw skeleton are both of an L-shaped structure.

7. The torque sensing bionic clamping jaw according to claim 6, wherein the L-shaped structures are provided with reinforcing ribs.

8. The torque sensing bionic clamping jaw according to claim 7, wherein the reinforcing ribs are triangular ribs.

9. The torque sensing bionic clamping jaw according to claim 1, wherein the left clamping jaw skeleton and the right clamping jaw skeleton are slidably connected to the substrate through a screw rod.

10. The torque sensing bionic clamping jaw according to claim 1, wherein the torque sensing bionic clamping jaw is of a symmetrical structure.
